(19) United States
(12) Patent Application Publication
(10) Pub. No.: US 2009/0277518 A1
(43) Pub. Date: Nov. 12, 2009

(54) Emergency motor vehicle reserve fuel system

(76) Inventor: Edward C. Sterling, (US)

Correspondence Address: GEORGE E. BULLWINKEL, 425 WOODSIDE AVENUE, HINSDALE, IL, 60521, US

(21) Appl. No.: 12/152,108

(22) Filed: May 12, 2008

(51) Int. Cl. F16K 31/00

(52) U.S. Cl. 137/505.16

(57) ABSTRACT

An emergency fuel supply system comprising a main fuel tank having a separate internal fuel reservoir which automatically refills itself with a reserve quantity of fresh fuel each time the main tank of the vehicle is refilled. A remotely controlled electric fuel pump or dump valve permits the vehicle operator to selectively jettison the reserve fuel into the main tank, either to provide a reserve supply in an emergency when the fuel in the main tank is depleted, or to empty the reserve tank of possibly stale fuel so that it may be refilled the next time the main tank is refilled.

### FIELD OF THE INVENTION

The present invention relates generally to providing a readily accessible emergency fuel reserve for a motor vehicle. More particularly, the invention relates to an auxiliary fuel tank which is automatically filled whenever the vehicle's main tank is filled, and then retains and retains and holds back a known quantity of fuel in case the main tank should become exhausted, whereupon the operator of the vehicle is enabled to activate and utilize the emergency fuel reserve by remote control.

### BACKGROUND OF THE INVENTION

The problem of providing a conveniently accessible emergency source of fuel for a motor vehicle has been addressed by a number of prior art patents, of which the following are representative examples.

Lotton et al. U.S. Pat. No. 4,188,969 (Feb. 19, 1980) “Reserve Fuel Tank System” discloses a multi-part automotive fuel tank with certain portions designated as reserve fuel. The reserve partitions can be activated by a solenoid-actuated valve which is controlled by the vehicle operator.

Stevens U.S. Pat. No. 4,763,621 (Aug. 16, 1988) “Automatically Functioning Emergency Fuel Supply System For Internal Combustion Engine”. A separate fuel tank is used as an operator-controlled emergency supply of fuel in the event of a temporary problem with the primary fuel supply.

Hack. Jr. U.S. Pat. No. 4,874,013 (Jan. 17, 1989) “Emergency Fuel System Apparatus”. This patent discloses a main fuel tank and two separate emergency fuel tanks, one of which cuts in automatically but temporarily when the main fuel supply is exhausted, thus giving the operator time to actuate the second emergency supply before the engine cuts out completely.

Gnudi, US Publication 2001/0023711 (filed Mar. 19, 2001) “Manual Fuel Supply Tap With Reserve Position”. This publication discloses a two-stage fuel tap which the operator can switch over from main tank to emergency supply by turning a lever, much like the two-position fuel tap commonly found in motorcycles.

Hubbard, et al. U.S. Pat. No. 6,113,660 (Sep. 5, 2000) “Emergency Fuel For Use In An Internal Combustion Engine And A Method Of Packaging The Fuel”. This is a jerry-can type of sealed container containing a shelf-stable combustible fuel for an automobile engine.

### OBJECTS OF THE PRESENT INVENTION

It is a principal object of the present invention to provide a reserve fuel tank within a main fuel tank positioned above the main tank fuel volume, instead of being incorporated into the bottom of the tank as disclosed by the Lotton et al. patent.

Additional objects and advantages of the present invention, not disclosed or suggested by the Lotton et al. patent or any of the other prior art cited above, include the feature by which the reserve fuel resides in an inner container which, when its dump valve is actuated, discharges directly into the main tank, so that no additional pick-up, piping or fuel pump is required.

An additional object and advantage of the present invention is that the reserve tank automatically re-fills each time the main tank is “topped up”. A related object and advantage is that even if the reserve reservoir is not actuated for a long time, the act of “topping up” the main tank will mix fresh fuel with the reserve, thus preventing the reserve from becoming “stale” over long periods of disuse.

### SUMMARY OF THE INVENTION

An emergency fuel supply system is disclosed, consisting of a main fuel tank having a separate internal fuel reservoir which automatically refills itself with a reserve quantity of fresh fuel each time the main tank of the vehicle is refilled. A remotely controlled electric fuel pump (or dump valve) permits the vehicle operator to selectively jettison the reserve fuel into the main tank, either to provide a reserve supply in an emergency when the fuel in the main tank is depleted, or to empty the reserve tank of possibly stale fuel so that it may be refilled the next time the main tank is refilled.

### BRIEF DESCRIPTION OF THE DRAWINGS

The preferred embodiment is herein described in detail with references to the drawings, where appropriate, wherein:

FIG. 1 is a schematic drawing showing the dashboard and fuel tank of an exemplary vehicle incorporating a first embodiment of the present invention incorporating a “hard-wired” control switch for controlling the electrically operated supplemental fuel pump (or dump valve) for discharging the contents of the reserve fuel tank into the main fuel tank.

FIG. 2 is a schematic drawing similar to FIG. 1 showing the dashboard and fuel tank of an exemplary vehicle incorporating a second embodiment of the present invention incorporating radio-controlled a “hard-wired” control switch for controlling the electrically operated supplemental fuel pump (or dump valve) for discharging the contents of the reserve fuel tank into the main fuel tank.

### DETAILED DESCRIPTION OF THE INVENTION

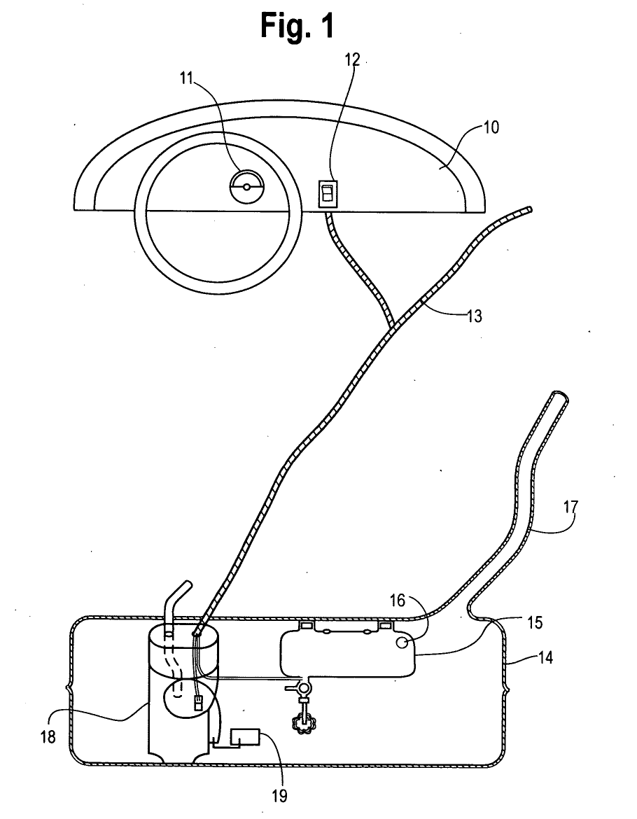

Referring to FIG. 1, there is shown in schematic form the dashboard 10 of an automobile or other fuel-consuming vehicle. A fuel level indicator 11 is positioned within the view of an operator which is capable of indicating the quantity of fuel remaining in the main tank, and which can indicate incipient fuel exhaustion to the vehicle operator.

In the even of incipient exhaustion, an emergency fuel supply activation switch 12 is positioned within the operator's convenient reach. In this first embodiment, the emergency fuel supply selector switch means comprising an activation switch 12 which is connected by a wiring harness 13 to the rest of the system, which is located within a main fuel tank 14. The main fuel tank or reservoir 14 encloses a smaller reserve fuel tank or reservoir 15 positioned in the upper portion of the main tank, so that as the fuel level in the main tank recedes, a reserve quantity is retained within the reserve tank 15 where it is available for use in an emergency. Positioned near the top of the reserve tank 15 is an upper opening 16. The main tank 14 is refilled from an external fuel source (not shown) through filler means including a filler neck 17. As the level of fuel in the main tank 14 rises, it will eventually rise to the level of the opening 16, at which point the fuel will spill over through the opening 16 into the reserve tank 15, filling it (unless it is already filled from a previous fill-up).

According to the invention, the main tank discharges fuel to the vehicle engine (not shown) by means of a first fuel supply means comprising a main fuel pump 18 of conventional design, which in the illustrated embodiment is contained within the main tank itself. Alternatively, it may be located at any convenient position external to the main tank 14 which will allow it to pick up fuel and convey it though a suitable conduit (not shown) to the vehicle engine. Also within the main fuel tank 14 is a fuel level sending unit 19 of conventional design, which in the illustrated embodiment is electrically connected to the fuel level indicator 11 on the dashboard 10.

As a central feature of the invention, the reserve fuel tank 15 is provided with second fuel supply means comprising a controllable discharge means 20, such as a reserve fuel pump or dump valve, through which the contents of the reserve fuel tank 15 may be selectively discharged by the vehicle operator into the main fuel tank 14. In the illustrated first embodiment of FIG. 1, the discharge means 20 is electrically actuated by the emergency fuel supply activation switch 12 through a hard-wired connection through the wiring harness 13.

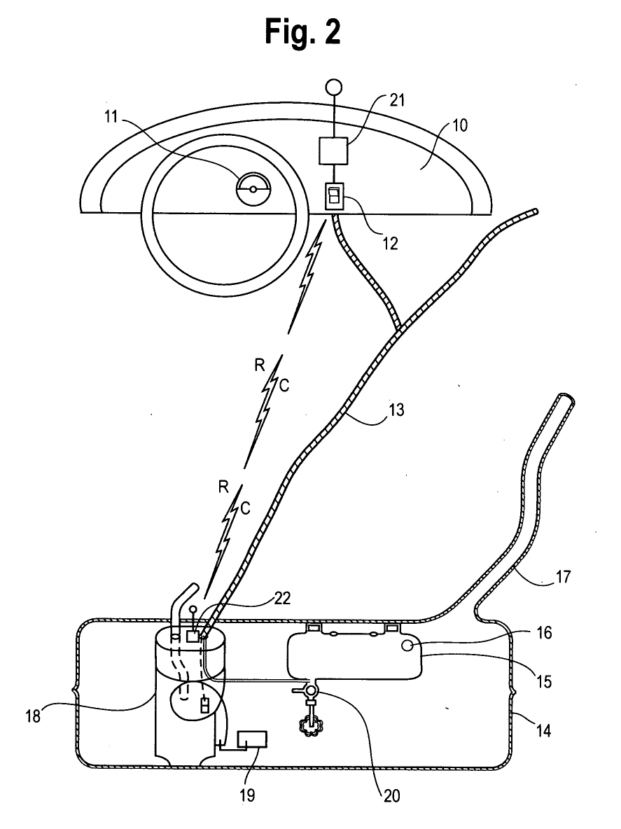

In the alternative embodiment of the invention depicted in FIG. 2, the controllable discharge means 20 is remotely actuated by wireless means. In this embodiment, a radio signal emitter 21 actuated by the emergency fuel supply activation switch 12 transmits a radio frequency signal from the dashboard 10 to a suitable radio signal receiver 22 located in or near the reserve fuel tank which actuates the controllable discharge means 20 to cause the contents of the reserve fuel tank 15 to be released into the main fuel tank 14 where it is available to be picked up by the main fuel pump 18 and utilized.

1. An emergency fuel supply system for an automotive vehicle having an internal combustion engine, characterized by:
(a) a fuel tank, said fuel tank having a main reservoir and filler means for introducing fuel therein,
(b) said main reservoir having a smaller auxiliary reservoir contained therein having an upper opening for receiving and being substantially filled with fuel whenever said main reservoir is substantially filled,
(c) fuel level indicator means for detecting and indicating the quantity of fuel remaining in said main reservoir, and for indicating incipient fuel exhaustion, to an operator of said vehicle,
(d) first fuel supply means for transferring fuel from said main reservoir to said engine,
(e) second fuel supply means for transferring fuel from said auxiliary reservoir to said first fuel supply means, and
(f) selector switch means for selectively activating said second fuel supply means to transfer fuel from said auxiliary reservoir to said first fuel supply means after said main fuel reservoir has been substantially exhausted.

2. An emergency fuel supply system for an automotive vehicle having an internal combustion engine, characterized by:
(a) a fuel tank, said fuel tank having a main reservoir and filler means for introducing fuel therein,
(b) said main reservoir having a smaller auxiliary reservoir contained therein having an upper opening for receiving and being substantially filled with fuel whenever said main reservoir is substantially filled,
(c) fuel level indicator means for detecting and indicating the quantity of fuel remaining in said main reservoir, and for indicating incipient fuel exhaustion, to an operator of said vehicle,
(d) first fuel supply means for transferring fuel from said main reservoir to said engine,
(e) second fuel supply means for transferring fuel from said auxiliary reservoir into said main reservoir,
(f) selector switch means for selectively activating said second fuel supply means to transfer fuel from said auxiliary reservoir to said first fuel supply means after said main fuel reservoir has been substantially exhausted.

3. The emergency fuel supply system of claim 1 or claim 2 in which each of said first and second fuel supply means is an electrically operated fuel pumps.

4. The emergency fuel supply system of claim 1 or claim 2 in which said first fuel supply means is an electrically operated fuel pump, and said second fuel supply means is an electrically operated dump valve.

5. The emergency fuel supply system of claim 1 or claim 2 in which said second fuel supply means is mechanically actuated by said selector switch means.

6. The emergency fuel supply system of claim 1 or claim 2 in which said second fuel supply means is electrically actuated by said selector switch means.

7. The emergency fuel supply system of claim 1 or claim 2 in which said second fuel supply means is activated by a radio frequency signal from said selector switch means.
